(19) United States
(12) Patent Application Publication
(10) Pub. No.: US 2018/0239445 A1
(43) Pub. Date: Aug. 23, 2018

(54) DEVICE AND METHOD FOR COMMUNICATING WITH A STYLUS

(71) Applicant: Microsoft Technology Licensing, LLC, Redmond, WA (US)

(72) Inventor: Eliyahu BAREL, Rosh HaAyin (IL)

(21) Appl. No.: 15/436,893

(22) Filed: Feb. 20, 2017

(51) Int. Cl. G06F 3/038; G06F 3/0354; G06F 3/042; G09G 3/32

(52) U.S. Cl. CPC G06F 3/0383; G06F 3/03545; G06F 3/03542; G09G 2354/00; G06F 3/0428; G06F 3/0425; G09G 3/32; G06F 3/0386

(57) ABSTRACT

A device comprising an electronic display, a digitizer sensor integrated with the electronic display and configured to track position of a stylus based on an electrostatic signal emitted by the stylus, an infrared (IR) emitter and a circuit configured to modulate the light emitted by the infrared emitter with data. The IR emitter is integrated with the electronic display and configured to emit infrared light in a field of view of the electronic display. The circuit together with the IR emitter is configured as a light communication channel for wirelessly transmitting the data to the stylus during interaction of the stylus with the digitizer sensor.

### FIELD AND BACKGROUND OF THE INVENTION

Signal emitting styluses such as active styluses, are known in the art for use with a digitizer system. An active stylus typically includes a battery to power generation and transmission of the signals emitted by the stylus. Positions of the stylus provide inputs to a computing device associated with the digitizer system and are interpreted as user commands. Often, the digitizer system is integrated with a display screen of the computing device to form a touch-screen.

### SUMMARY OF THE INVENTION

The disclosure in some embodiments relates to a computing device that communicates with a stylus using two independent communication channels that can be operated simultaneously. A first channel is an electrostatic channel including a digitizer sensor that picks up signals transmitted by a stylus and tracks position of the stylus based on the signals detected. A second channel is an optical channel including a light source, e.g. an Infrared (IR) transmitter integrated with a display screen of the device. The light source is configured to transmit data to the stylus while the stylus is within the field of view of the display screen and at a distance ranging from 0-100 cm from the display screen. Optionally, the optical channel is also used to transmit data from the stylus to the computing device and the computing device includes a light receiver and a circuit to demodulate data received via the optical channel.

Unless otherwise defined, all technical and/or scientific terms used herein have the same meaning as commonly understood by one of ordinary skill in the art. Although methods and materials similar or equivalent to those described herein can be used in the practice or testing of embodiments of the disclosure, example methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some implementations are herein described, by way of example only, with reference to the accompanying drawings. With specific reference now to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

In the drawings:

FIG. 1 is a simplified block diagram of an example computing device and an example stylus;

FIGS. 2A, 2B and 2C are simplified schematic drawings of an example computing device with LEDs operated to transmit data and two example edge lit backlight units including the LEDs;

FIGS. 3A and 3B are simplified schematic drawings of another example computing device with LEDs operated to transmit data and an example direct lit backlight unit including the LED;

FIG. 4 is a simplified schematic drawing of an example OLED display screen including a plurality pixels having an IR sub-pixel that is operated to transmit data;

FIG. 5 is a simplified schematic drawing of an example computing device including an IR LED integrated within a frame of the computing device;

FIG. 6 is a simplified flow chart of an example method for a computing device to communicate with a stylus; and

FIGS. 7A and 7B are simplified schematic views of an example stylus configured to receive and demodulate a light signal.

### DESCRIPTION OF SPECIFIC EMBODIMENTS OF THE INVENTION

According to some example implementations, a computing device includes an optical uplink channel that transmits data to a stylus while the stylus is approaching a display screen of a computing device or interacting with a capacitive based touch screen of the computing device. The data may be transmitted by modulating light emitted of a light source in a field of view of the display screen. Communication with the stylus may be initiated at distances between 0-100 cm from the display screen. Modulation may include one or more of pulse frequency modulation, pulse width modulation, pulse shape modulation and modulation of illumination intensity. The stylus may include one or more photo-diodes that detect the modulated light and a circuit that demodulates the light signal. Data transmitted via the optical uplink channel may include, for example, protocols, working modes and identification information of the computing device. In addition, data transmitted via the optical uplink channel may include updates related to input received from the capacitive based touch screen, e.g. the digitizer system of the computing device.

In some example implementations, an IR Light Emitting Diode (LED) is integrated with the computing device and is operated to transmit the data based on light modulation. The IR LED may be integrated within a backlight of a Liquid Crystal Display (LCD) and may emit IR light in a field of view of the LCD. Optionally, modulation is also included to avoid interference with ambient light. Alternatively, when the computing device includes an OLED display, IR sub-pixels may be added to the Organic LED (OLED) Thin Film Transistor (TFT) substrate. In another example implementation, an IR laser projector or LED installed on a frame of a display may be operated to transmit data to a stylus interacting with the display. The IR light may be modulate to include data based on pulse frequency modulation, pulse width modulation, pulse shape modulation, intensity modulation as well as a combination of one or more of pulse frequency, width, shape and intensity modulations.

In yet another implementation, visual light emitted by the display may be modulated for example by flickering the visual light and the modulation of the visual light may be picked up by the stylus Optionally, a light source of the display screen may be flickered in coordination with TFT pixel or sub-pixel switching. The flickering is selected to be at a frequency that is substantially not noticeable to a user viewing the display.

In some exemplary implementations, the computing device may also include an optical downlink channel for receiving data from the stylus. Optionally, the stylus may include a LED, e.g. an IR LED that is modulated to transmit data to the computing device.

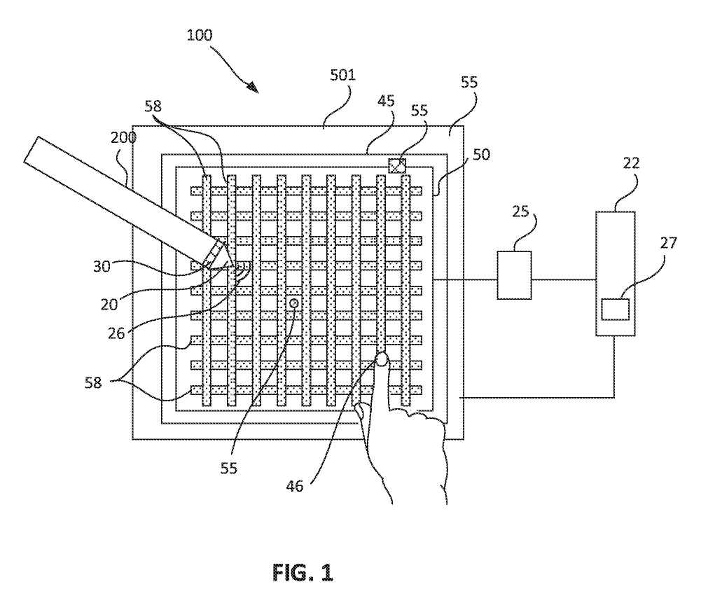

Reference is now made to FIG. 1 showing a simplified block diagram of an example computing device and an example stylus. A computing device 100 includes a display screen 45 that is integrated with a digitizer sensor 50. Digitizer sensor 50 may be a grid based capacitive sensor formed from conductive strips 58 that are operative to detect both input by a stylus 200 transmitting a signal 26 and input by one or more fingertips 46 or other conductive objects. Digitizer circuit 25 controls operation of digitizer sensor 50 and communicates with host circuit 22. Typically, digitizer circuit 25 tracks location of stylus 200 and fingertips 46 based on inputs received by digitizer sensor 50. Digitizer circuit 25 may alternate between sampling output to detect signal 26 and scanning conductive strips 58 with a triggering signal to sense one or more fingertips 46.

Output from digitizer circuit 25 is reported to host 22. The output reported may include coordinates of stylus 200, a level of pressure state applied on a tip 20 of stylus 200 and coordinates of one or more fingertips 46 interacting with digitizer sensor 50. Optionally, digitizer circuit 25 reports a hover or ink state for stylus 200. Optionally, some or all of the functionalities of digitizer circuit 25 are integrated or included in host 22.

According to some implementations, computing device 100 wirelessly transmits data to stylus 200 by emitting a dedicated optical signal in the field of view of display 45. The dedicated optical signal may be emitted by a light source 55 integrated with display 45 or with a frame 501 around display 45. The optical signal may be in a non-visible range, e.g. IR, NIR range or in the visible range. The dedicated optical signal may be controlled and defined by an optical communication module 27 included or integrated with host 22.

Stylus 200 may include one or more optical windows 30 through which the optical signal may be received. Optionally, the optical windows 30 are positioned near tip 20 of stylus 200. In some example implementations, stylus 200 may also transmit an optical signal via optical window 30 that may be received by computing device 100.

According to some example implementations, light source 55 is operated in parallel with digitizer circuit 25. Optionally, stylus 200 may transmit signal 26 while receiving data from light source 55. In some example implementations, operation of digitizer circuit 25 is synchronized with transmission of light source 55. For example, computing device may alternate between sampling digitizer sensor to detect signal 26 and transmitting input to stylus 200 with light source 55. Data transmitted by light source 55 may also provide a synchronization signal based on which stylus 200 may synchronize its transmission with a sampling cycle of digitizer circuit 25. Optionally, light source 55 is operated to transmit data while digitizer circuit 25 is scanning digitizer sensor 50 to detect fingertips 46 and operation of light source 55 may be paused while digitizer circuit 25 is sampling output to detect signal 26 emitted by stylus 200. Stylus 200 may for example alternate between receiving and processing an optical signal and transmitting signal 26.

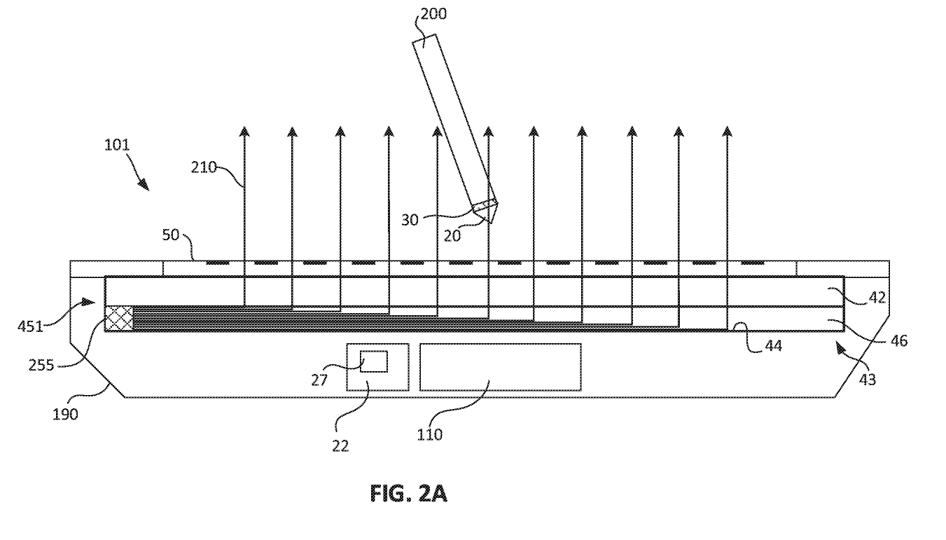

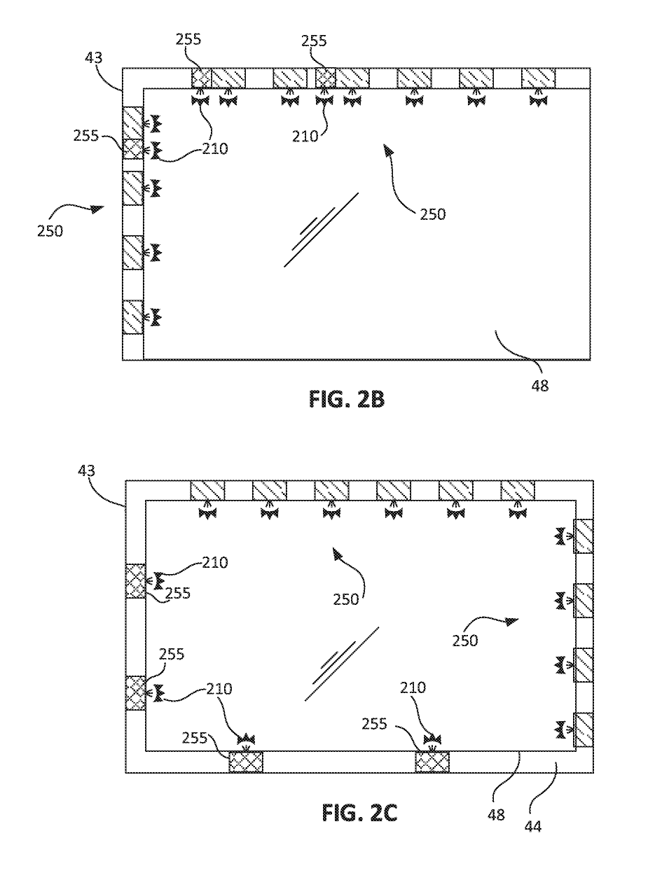

Reference is now made to FIGS. 2A, 2B and 2C showing simplified schematic drawings of an example computing device with LEDs operated to transmit data and two example edge lit backlight units including the LEDs. A computing device 101 may generally include a digitizer sensor 50 overlaid on a display 451, host circuit 22 and power supply 110. Display 451 may be for example an LCD display including a TFT module 42 and an edge lit backlight unit 43. The edge lit backlight unit 43 may include an LED array strip 250 along one or more edges of display 351 (as shown in FIGS. 2B and 2C) and connected to a light guide layer 48. Typically, backlight unit 43 is overlaid on a reflective surface 44. In some example implementations, one or more dedicated LEDs 255 for transmitting data to stylus 200 may be integrated with edge lit backlight unit 43. LEDs 255 may provide illumination 210 in a Field of View (FOV) of display 451 and stylus 200 may receive illumination 210 via an optical window 30 while tip 20 is interacting with display 451. Optical communication module 27 may modulate illumination 210 with data.

Stylus 200 may include one or more photo-detectors or other light receivers that picks up illumination 210 through optical window 30 and demodulate data included in the illumination 210. Optical window 30 may for example be a ring shaped window near tip 20 or for example may be integrated with tip 20.

LEDs 255 may be integrated as part of LED array strip 250 (as shown in FIG. 2B). Alternatively, one or more LEDs in array 250 typically used to illuminate display 451 may be connected to optical communication module 27 and operated instead to transmit data to stylus 200. In another example, LEDs 255 may be integrated on one or more edges that are not occupied by LED array strip 250 of display 451 (FIG. 2C). LEDs 255 may be for example an IR LED, NIR LED or other LED in the non-visible range so that data may be transmitted to stylus 200 without disrupting illumination of display 451. Alternatively, LEDs 255 may be in the visible range and modulated to flicker at a frequency that would not be substantially noticeable to a user, e.g. greater than 60 Hz and between 60 Hz and 1 MHz.

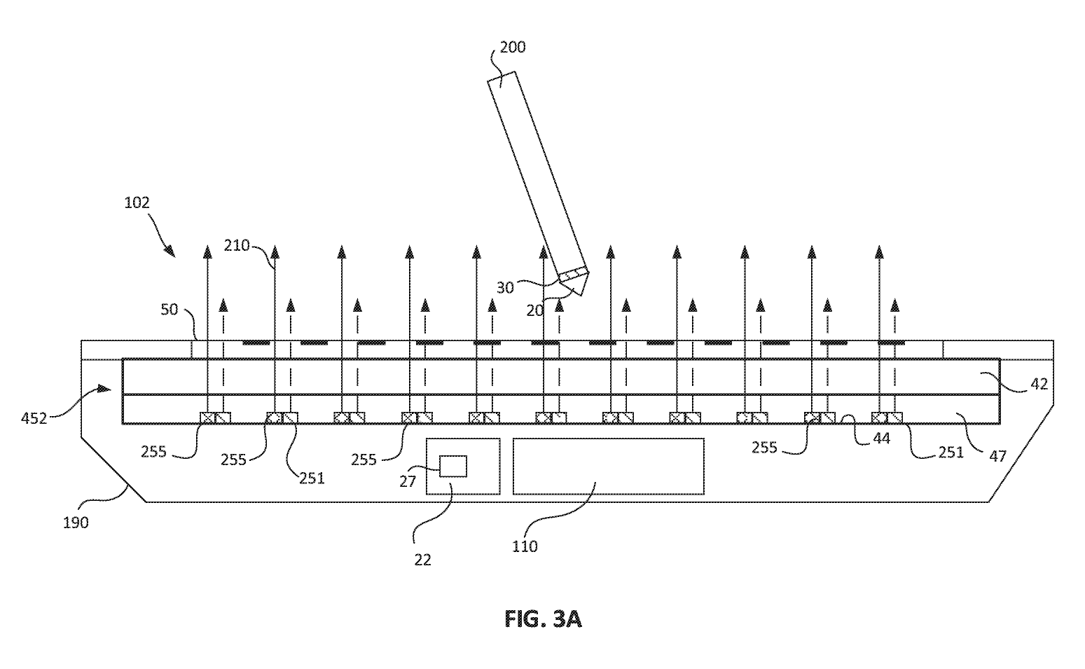

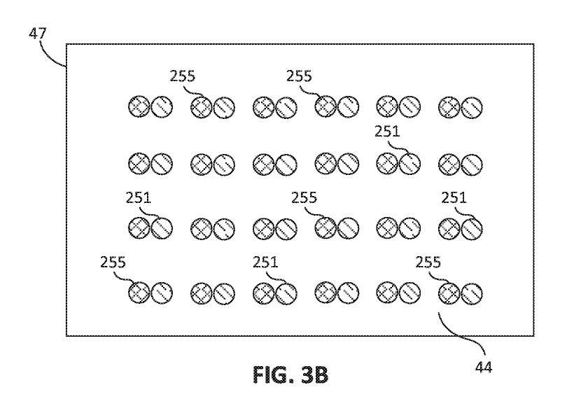

Reference is now made to FIGS. 3A and 3B showing simplified schematic drawings of another example computing device with LEDs operated to transmit data and an example direct lit backlight unit including the LED. In some example implementations, computing device 102 may include a direct lit backlight unit 47 instead of an edge lit unit. Typically, direct light backlight unit 47 includes a matrix of LEDs 251 for illuminating display 452. In some example implementations, one or more dedicated LEDs 255 for transmitting data to stylus 200 may be integrated with direct lit backlight unit 47. LEDs 255 may provide illumination 210 in a FOV of display 452 and stylus 200 may receive illumination 210 via optical window 30 while tip 20 is interacting with display 451. Optical communication module 27 may modulate illumination 210 to include data.

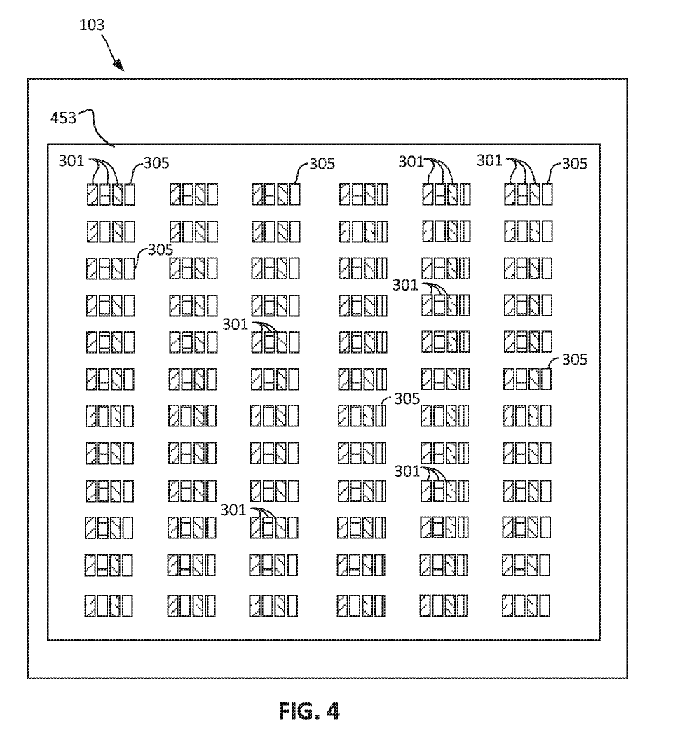

Reference is now made to FIG. 4 showing simplified schematic drawing of an example OLED display screen including a plurality of pixels having an IR sub-pixel that is operated to transmit data. A computing device 103 may include an

OLED display 453. In some exemplary implementations, display 453 may be integrated with pixels including dedicated LED sub-pixels 305 for transmitting data to a stylus. Optionally, dedicated sub-pixels 305 are IR LEDs and may be positioned alongside one or more RGB sub-pixels 301. Dedicated sub-pixels 305 are typically connected optical communication module 27 that modulates its illumination to include data. The modulated illumination may be picked up by stylus 200 (shown in FIG. 1) and demodulated with a circuit stylus 200.

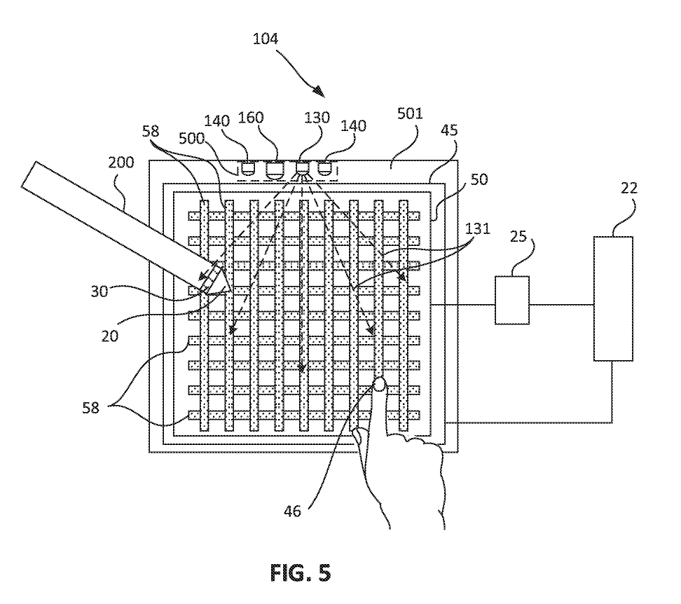

Reference is now made to FIG. 5 showing a simplified schematic drawing of an example computing device including an IR LED integrated within a frame of the computing device. A computing device 104 may include a camera unit 500, e.g. a 2D or 3D camera unit). Camera unit 500 may typically be integrated in a frame 501 of display 45 and may include for example, a RGB camera 160, one or more IR cameras 140 and an IR laser projector 130. IR laser projector 130 may project IR light 131 in a FOV of display 45. In some example implementations, host circuit 22 may transmit data to stylus 200 by modulating light 301 projected by IR laser projector 130. Stylus 200 receives light 301 through optical window 30. Light 301 penetrating through optical window may be collected with one or more photo-detectors housed in stylus 200. In some example implementation, computing device 104 may also receive optical input from stylus 200 with IR camera 140 as well as via conductive strips 58. Optionally, stylus 200 additionally includes an IR laser projector that may emit light through optical window 30. Light emitted by the IR laser projected may be modulated with data and received by IR camera 140.

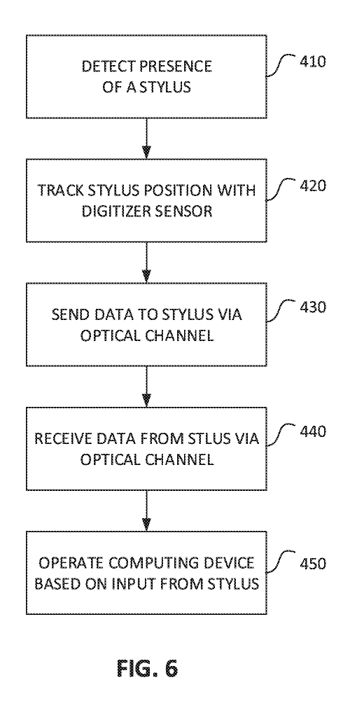

Reference is now made to FIG. 6 showing a simplified flow chart of an example method for a computing device to communicate with a stylus. According to some example implementations, a computing device detects presence of a stylus (block 410). In some example implementations, presence is detected based on a stylus responding to a light signal such as an IR signal transmitted by the optical communication channel of the computing device. Optionally, the light signal may be operated as a wake up trigger to prompt the stylus to transmit a signal to the digitizer sensor of the computing device. Optionally, data transmitted with the light signal may provide information for synchronizing the stylus with the digitizer system. Once presence of the stylus is detected, the digitizer system may track position of the stylus (block 420) and the computing device may send data to the stylus via the optical communication channel (block 430). Data sent to the stylus may update regarding a system type that may require a change in a stylus protocol, frequency of transmission or intensity of signal. The data may also provide user identification. Optionally, each IR (embedded in display) is modulated differently and provides to the stylus position indication by optical data. In some example implementations, the optical communication channel provides for communication at distances beyond which an electrostatic signal may be detected with a digitizer system of with the computing device. Optionally, the computing device additionally includes photo-detectors that receive data from stylus via the optical communication channel (block 440). According to some example implementations, the computing device may be operated based on input from stylus (block 450).

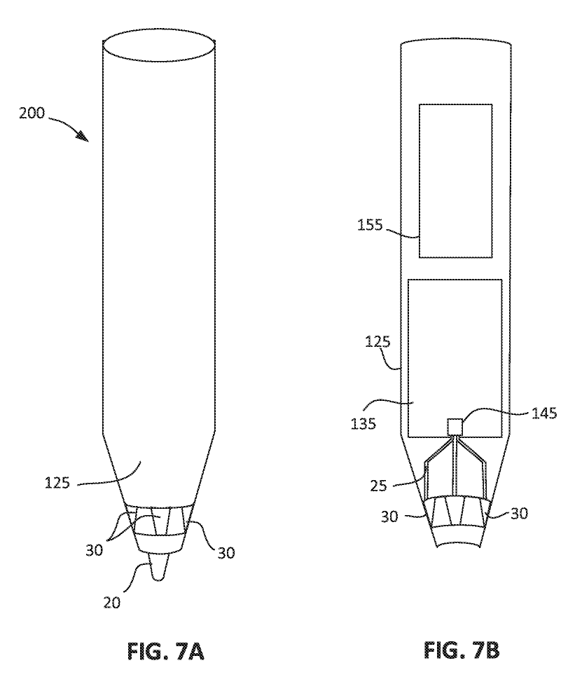

FIGS. 7A and 7B are simplified schematic views of an example stylus configured to receive and demodulate a light signal. A stylus 200 includes a housing 125 including one or more optical windows 30. Optionally windows 30 may be transparent when configured to detect visible light or may be transparent or opaque when configured to detect light in the non-visible range such as IR light. One or more optical fibers 125 may be attached to optical window 30 and may transmit the light received to a light receiver 145 such as a photo-diode 145. Photo-diode may be electrically connected to a circuit 135 that is powered with a battery or super capacitor 155. According to some exemplary implementation, light detected by light receiver 145 is demodulated with circuit 135. Data received by stylus 200 may include for example information regarding protocols, working mode, and ID information of the computing device with which the stylus is communicating.

According to an aspect of some implementations of the present disclosure, a device includes an electronic display; a digitizer sensor integrated with the electronic display and configured to track position of a stylus based on an electrostatic signal emitted by the stylus; an infrared (IR) emitter integrated with the electronic display and configured to emit infrared light in a field of view of the electronic display; and a circuit configured to modulate the light emitted by the infrared emitter with data, wherein the circuit together with the IR emitter is configured as a light communication channel for wirelessly transmitting the data to the stylus during interaction of the stylus with the digitizer sensor.

Optionally, the IR emitter is integrated with a frame around the electronic display and is configured to emit light across a surface of the electronic display.

Optionally, the electronic display includes an edge lit backlight unit and the IR emitter is integrated edge lit backlight unit.

Optionally, the IR emitter is integrated with a LED array strip of the backlight unit, wherein the LED array strip is configured to illuminate the electronic display.

Optionally, an LED array strip is positioned along one or two edges of the backlight unit and wherein the IR emitter is integrated on an edge of the edge lit backlight unit other than the one or two edges occupied by the LED array strip.

Optionally, the electronic display includes a direct lit backlight unit including a matrix of LEDs configured to illuminate the electronic display and wherein the IR emitter is integrated between the matrix of the LEDs forming the direct lit backlight unit.

Optionally, the electronic display includes a direct lit backlight unit including a matrix of LEDs configured to illuminate the electronic display and wherein the IR emitter is below the direct lit backlight unit.

Optionally, the electronic display is an Organic LED (OLED) display including illumination pixels each pixel formed with a plurality of sub-pixels and wherein the IR emitter is one of the sub-pixels.

Optionally, the device includes an array of IR emitters integrated with the electronic display.

Optionally, the device includes a camera unit, the camera unit including an IR LED laser projector, wherein the circuit is configured to modulate the light emitted by the IR LED laser projector to include the data.

Optionally, the circuit is configured to modulate the light based on one or more of pulse frequency, pulse width, pulse shape and pulse intensity.

According to an aspect of some implementations of the present disclosure, a system comprises a computing device comprising: an electronic display; a digitizer sensor integrated with the electronic display and configured to pick up an electrostatic signal emitted by a stylus; a digitizer circuit configured to sample output from the digitizer sensor and to track position of the stylus based on the electrostatic signal detected; an infrared (IR) emitter integrated with the electronic display and configured to emit infrared light in a field of view of the electronic display; and a circuit configured to modulate the light emitted by the infrared emitter with data, wherein the circuit together with the IR emitter is configured as a light communication channel for wirelessly transmitting the data to the stylus during interaction of the stylus with the digitizer sensor; and a stylus comprising: a housing; an optical window integrated with the housing; a tip extending from the housing; a light detector configured to detect an IR signal emitted in a field of view of the electronic display while interacting with the electronic display; and a circuit configured to demodulate data included in the light signal and to transmit an electrostatic signal.

Optionally, the light signal and the electrostatic signal are configured to be transmitted substantially simultaneously.

Optionally, the light signal includes a synchronization signal configured to synchronize the transmission of the electrostatic signal with sampling of the digitizer sensor.

Optionally, the electrostatic signal emitted is modulated and wherein the modulation is based on the data demodulated from the light signal.

Optionally, the electrostatic signal transmitted by the stylus is initiated based on the stylus receiving the light signal.

According to an aspect of some implementations of the present disclosure, a method comprises tracking position of a stylus that is interacting with a touch screen based on an electrostatic signal transmitted by the stylus; transmitting data to the stylus with an IR emitter integrated with an electronic display of the touch screen and configured to emit a modulated light signal; and wherein the stylus is configured to adjust its operation based on the data received.

Optionally, the method comprises transmitting data from the stylus to the touch screen with a second IR emitter integrated in the stylus; and receiving data from the stylus with an IR receiver integrated with an electronic display of the touch screen.

According to an aspect of some implementations of the present disclosure, a device comprises a device comprising: an electronic display including a plurality of LEDs configured to illuminate the electronic display; a digitizer sensor integrated with the electronic display and configured to track position of a stylus based on an electrostatic signal emitted by the stylus; and a circuit configured to modulate at least one of the plurality of LEDs based on flickering light emitted by the at least one of the plurality of LEDs at a frequency above 60 Hz.

Optionally, the flickering is coordinated with TFT pixel or sub-pixel switching.

Certain features of the examples described herein, which are, for clarity, described in the context of separate embodiments, may also be provided in combination in a single embodiment. Conversely, various features of the examples described herein, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

What is claimed is:

1. A device comprising:
an electronic display;
a digitizer sensor integrated with the electronic display and configured to track position of a stylus based on an electrostatic signal emitted by the stylus;
an infrared (IR) emitter integrated with the electronic display and configured to emit infrared light in a field of view of the electronic display; and
a circuit configured to modulate the light emitted by the infrared emitter with data, wherein the circuit together with the IR emitter is configured as a light communication channel for wirelessly transmitting the data to the stylus during interaction of the stylus with the digitizer sensor.

2. The device of claim 1, wherein the IR emitter is integrated with a frame around the electronic display and is configured to emit light across a surface of the electronic display.

3. The device of claim 1, wherein the electronic display includes an edge lit backlight unit and the IR emitter is integrated edge lit backlight unit.

4. The device of claim 3, wherein the IR emitter is integrated with a LED array strip of the backlight unit, wherein the LED array strip is configured to illuminate the electronic display.

5. The device of claim 3, wherein an LED array strip is positioned along one or two edges of the backlight unit and wherein the IR emitter is integrated on an edge of the edge lit backlight unit other than the one or two edges occupied by the LED array strip.

6. The device of claim 1, wherein the electronic display includes a direct lit backlight unit including a matrix of LEDs configured to illuminate the electronic display and wherein the IR emitter is integrated between the matrix of the LEDs forming the direct lit backlight unit.

7. The device of claim 1, wherein the electronic display includes a direct lit backlight unit including a matrix of LEDs configured to illuminate the electronic display and wherein the IR emitter is below the direct lit backlight unit.

8. The device of claim 1, wherein the electronic display is an Organic LED (OLED) display including illumination pixels each pixel formed with a plurality of sub-pixels and wherein the IR emitter is one of the sub-pixels.

9. The device of claim 1, comprising an array of IR emitters integrated with the electronic display.

10. The device of claim 1, comprising a camera unit, the camera unit including an IR LED laser projector, wherein the circuit is configured to modulate the light emitted by the IR LED laser projector to include the data.

11. The device of claim 1, wherein the circuit is configured to modulate the light based on one or more of pulse frequency, pulse width, pulse shape and pulse intensity.

12. A system comprising:
a computing device comprising:
an electronic display;
a digitizer sensor integrated with the electronic display and configured to pick up an electrostatic signal emitted by a stylus;
a digitizer circuit configured to sample output from the digitizer sensor and to track position of the stylus based on the electrostatic signal detected;
an infrared (IR) emitter integrated with the electronic display and configured to emit infrared light in a field of view of the electronic display; and
a circuit configured to modulate the light emitted by the infrared emitter with data, wherein the circuit together with the IR emitter is configured as a light communication channel for wirelessly transmitting the data to the stylus during interaction of the stylus with the digitizer sensor; and
a stylus comprising:
a housing;
an optical window integrated with the housing;
a tip extending from the housing;
a light detector configured to detect an IR signal emitted in a field of view of the electronic display while interacting with the electronic display; and
a circuit configured to demodulate data included in the light signal and to transmit an electrostatic signal.

13. The system of claim 12, wherein the light signal and the electrostatic signal are configured to be transmitted substantially simultaneously.

14. The system of claim 12, wherein the light signal includes a synchronization signal configured to synchronize the transmission of the electrostatic signal with sampling of the digitizer sensor.

15. The system of claim 12, wherein the electrostatic signal emitted is modulated and wherein the modulation is based on the data demodulated from the light signal.

16. The system of claim 12, wherein the electrostatic signal transmitted by the stylus is initiated based on the stylus receiving the light signal.

17. A method comprising:
tracking position of a stylus that is interacting with a touch screen based on an electrostatic signal transmitted by the stylus;
transmitting data to the stylus with an IR emitter integrated with an electronic display of the touch screen and configured to emit a modulated light signal; and wherein the stylus is configured to adjust its operation based on the data received.

18. The method according to claim 17, comprising:
transmitting data from the stylus to the touch screen with an second IR emitter integrated in the stylus; and
receiving data from the stylus with an IR receiver integrated with an electronic display of the touch screen.

19. A device comprising:
an electronic display including a plurality of LEDs configured to illuminate the electronic display;
a digitizer sensor integrated with the electronic display and configured to track position of a stylus based on an electrostatic signal emitted by the stylus; and
a circuit configured to modulate at least one of the plurality of LEDs based on flickering light emitted by the at least one of the plurality of LEDs at a frequency above 60 Hz.

20. The device of claim 19, wherein the flickering is coordinated with TFT pixel or sub-pixel switching.
